(19) United States
(12) Patent Application Publication
(10) Pub. No.: US 2002/0087956 A1
(43) Pub. Date: Jul. 4, 2002

(54) System and method for linear processing of software modules

(76) Inventor: Pierre-Alain Darlet, Alameda (FR)

Correspondence Address: KENYON & KENYON, ONE BROADWAY, NEW YORK, NY, 10004, US

(21) Appl. No.: 09/754,785

(22) Filed: Jan. 4, 2001

Related U.S. Application Data
(60) Provisional application No. 60/235,534, filed on Sep. 26, 2000.

(51) Int. Cl. G06F 9/45

(52) U.S. Cl. 717/159

(57) ABSTRACT

A method is described that includes receiving a software module, the software module including references, at least some of the references being backward references; and reordering the software module to remove at least some of the backward references. The method may be used in conjunction with a linker/loader to facilitate sequential linking and loading of the software module.

### BACKGROUND INFORMATION

In computer systems, and in particular, as part of computer operating systems and software development environments, tools may be provided to allow the “loading” and “linking” of “software modules” (e.g., object files, or relocatable object modules) for execution, for example, as part of an application program. Such software modules may include instructions and/or data structures, each positioned at particular locations in the software module. Instructions in software modules may make references to instructions or data structures both inside and outside of the software module (for example, in another software module).

Before the execution of an instruction with references can be accomplished, the references in the instruction need to be resolved. References are typically represented by “symbols” used to represent a desired location. A resolution procedure includes “defining” a symbol, assigning a value (e.g., a memory address) to the symbol by the software module that contains the locations to which access is to be allowed, and then substituting the symbol value for any reference to the symbol used in that software module or in other software modules.

In conventional loading and linking implementations, for example, in loaders and linkers using the conventional ELF Format, the loading and linking procedure requires the ability to access the software module nonsequentially. See, e.g., “Executable and Linkable Format”, Tools Interface Standards, Portable Formats Specification, Version 1.1, expressly incorporated herein by reference. In many systems this is not a problem, because disks, or other I/O devices supporting a file system, typically allow nonsequential access to entries within a file.

However, there are situations where nonsequential I/O access may not be available; e.g., in systems without I/O devices supporting nonsequential access, when the software module is loaded from a serial network connection, or when using a bootloader. In situations without nonsequential I/O access, alternative procedures must be used if linking and loading the software module requires nonsequential access to the software module.

One alternative procedure is to simulate random access on a sequential device, for example, by using multiple sequential reads of the software module. Although many sequential I/O devices or network protocols can simulate random (nonsequential) access to the software module, some raw serial access I/O devices or network connections cannot practically simulate random access. Also, simulating nonsequential access on a sequential device or connection is generally inefficient for large software modules, especially via a slow network connection or device.

In a second alternative procedure, the entire software module can be read into memory before beginning the loading and linking procedure, thus allowing random access to the module file that is stored in memory. However, this procedure is unsuitable for systems where the software modules are large relative to the amount of memory available, e.g., in an embedded system.

### SUMMARY OF THE INVENTION

In an example embodiment according to the present invention, a method is provided for receiving a software module, the software module including references, at least some of the references being backward references. The method includes reordering the software module to remove at least some of the backward references.

An example embodiment according to the present invention also provides a system including a reorder module, the reorder module configured to receive a software module. The software module includes references, at least some of the references being backward references. The reorder module reorders the software module to remove at least some of the backward references.

An example embodiment according to the present invention also provides a method, including receiving a software module sequentially. The software module has at least one symbol reference. The method further includes loading the software module into a target memory space; and resolving the symbol reference in the software module without storing the entire software module in local memory while the symbol reference is resolved.

An example embodiment according to the present invention also provides a system, including a linker. The linker is configured to sequentially receive a software module having at least one symbol reference. The linker resolves the symbol reference, the linker storing less than the entire software module in local memory during the resolution of the symbol reference.

An example embodiment according to the present invention also provides a software module, including a symbol table, at least one component located before the symbol table, and at least one backward reference from the symbol table, wherein the software module includes no backward references from locations before the symbol table.

An example embodiment according to the present invention also provides an article of manufacture comprising a computer-readable medium having stored thereon instructions adapted to be executed by a processor. The instruction, when executed, define a series of steps to be used to control the playing of the contents of a data object. The steps include: receiving a software module, the software module including references, at least some of the references being backward references; and reordering the software module to remove at least some of the backward references.

An example embodiment according to the present invention also provides an article of manufacture comprising a computer-readable medium having stored thereon instructions adapted to be executed by a processor. The instructions, when executed, define a series of steps to be used to control the playing of the contents of a data object. The steps include: receiving a software module sequentially, the software module having at least one symbol reference; loading the software module into a target memory space; and resolving the symbol reference in the software module without storing the entire software module in local memory at one time.

### BRIEF DESCRIPTION OF THE DRAWINGS

FIG. 1 is a flowchart of an example compilation, load, and link procedure, according to the present invention.

FIG. 2 shows an example software module.

FIG. 3 shows an example reordered software module, according to the present invention.

FIG. 4 shows a flowchart of an example software module conversion procedure, according to the present invention.

FIG. 5 shows a flowchart of the example loading and linking procedure, according to the present invention.

FIG. 6 shows a flowchart of an example loading procedure, according to the present invention.

FIG. 7 shows a flowchart of an example symbol registration procedure, according to the present invention.

FIG. 8 shows a flowchart of an example software module and symbol relocation procedure, according to the present invention.

FIG. 9 shows an example symbol resolution procedure, according to the present invention.

FIG. 10 shows an example linker/loader and example data structures that may be used by the example linker/loader, according to the present invention.

FIG. 11 shows an example system symbol table, according to the present invention.

FIG. 12 shows an example reference data structure of the system symbol table of FIG. 11, according to the present invention.

FIG. 13 shows an example software module list data structure, according to the present invention.

FIG. 14 shows an example link status information data structure, according to the present invention.

FIG. 15 shows a block diagram of an example computer environment including a linker/loader, according to the present invention.

### DETAILED DESCRIPTION

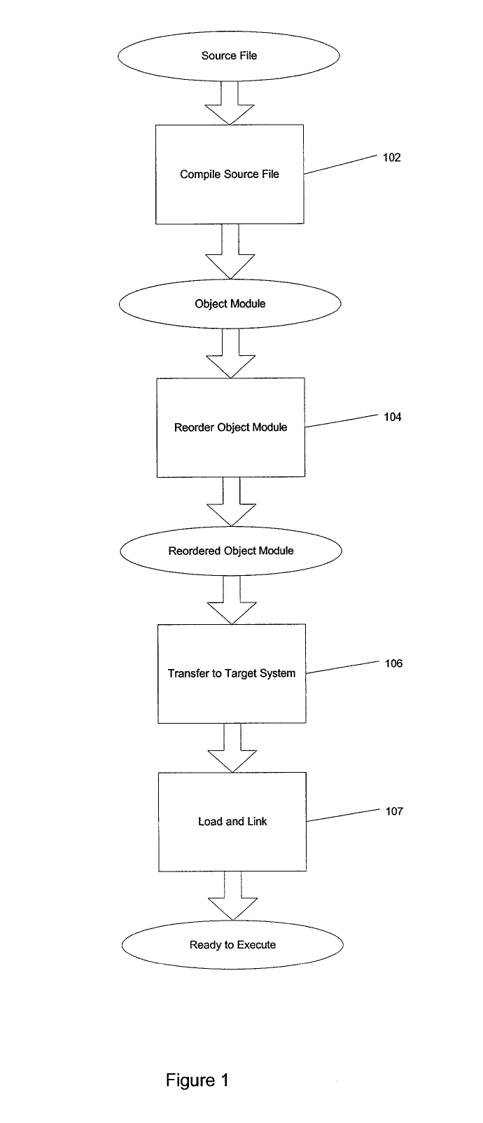

FIG. 1 illustrates a procedure by which a program may be compiled, loaded, and linked according to an example embodiment of the present invention. In step 102, a software module, for example, a source code file in a common programming language such as C or C++, is compiled, producing a compiled software module or “object module”. The compiled software module may be in any object code format, for example, in the conventional ELF format. The compiled software module typically includes “backward references”; i.e., if the compiled software module is scanned sequentially, the module includes pointers or indices that reference an earlier portion of the compiled software module.

In step 104, in accordance with the present invention, the software module is processed into an alternative format, eliminating many of the backward references in the file, and placing the components of the software module in a predetermined order. In the example embodiment, this may be accomplished as a separate step using the procedure describe below. However, skilled practitioners of the pertinent art will recognize that other procedures of generating a software module in the alternative format are possible. Skilled practitioners will further recognize that the illustrated conversion procedure may be readily adapted to different languages and file formats, and that the reordering step may be combined with the compilation step, so that the compiler directly produces a file of the appropriate format. However, such an approach may require modification to the compiler. The example embodiment may also be altered to include greater numbers of backward references in the software module while still needing only sequential reading of the software module. This may require greater amounts of memory in the linking and loading procedure (although still less than storing the whole software module in memory at one time).

Note that, particularly for embedded systems, the compilation may take place on a so-called “host” system or development system, while the linking can occur on either the host or a “target system.” Accordingly, in step 106, the reordered object code module optionally may be transferred to the “target system” in situations where the compilation is performed on the host system and the linking on the target system. This transfer may be accomplished by using, for example, a tape, a shared file system, a network connection, or any other means of file transfer. Once the file is transferred to the target system, the file may be loaded and linked in step 107. The processed software module may be linked without nonsequential reading of the software module, and with only a portion of the module saved in the linker/loader's memory throughout the linking procedure, rather than the entire software module.

Example Software Module

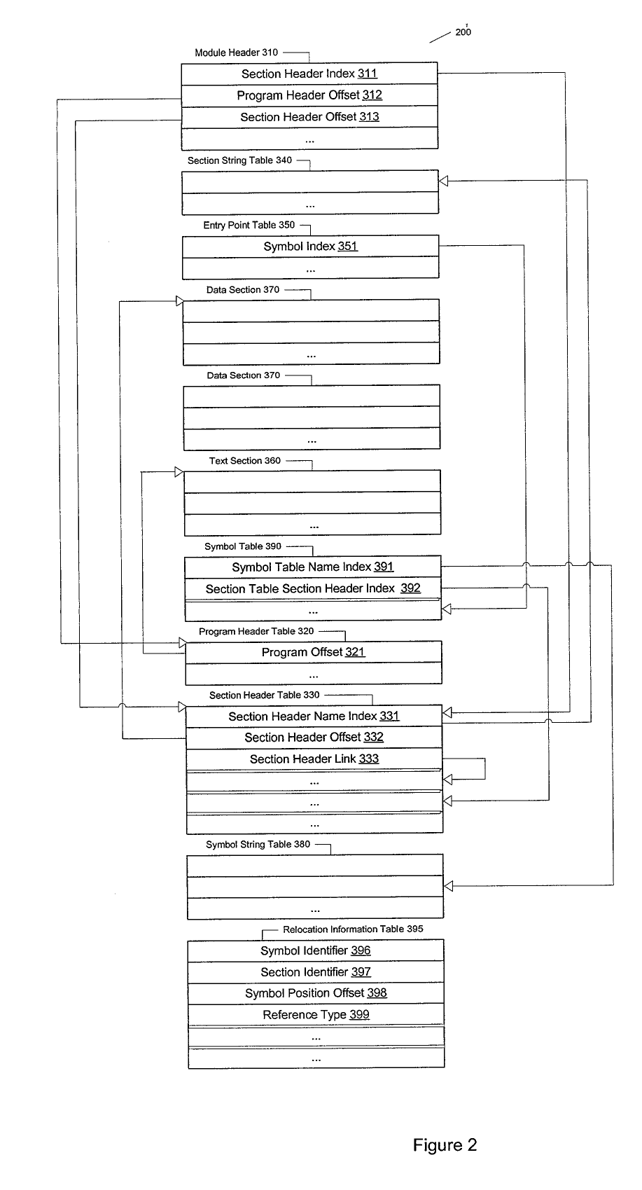

FIG. 2 illustrates an example software module 200, that may be processed according to the present invention (e.g., in step 104 of FIG. 1). The software module may be produced by a compiler, by another tool in an operating system or software development environment, or by other conventional means. The software module may be a relocatable object module in the ELF Format.

The software module may have a number of components, including headers, sections of various types, and string tables, described in more detail below. When the software module is read, the components of the software module may be identified by any conventional means of identifying components of a software module, e.g., using special start and end symbols to mark the start and end of components, including an index in a pre-specified location (e.g., in a module or file header) that identifies the start and end of each component, or any other conventional means.

In the illustration of the example software module, arrows on the left side of FIG. 2 show offsets in the module file. Offsets may indicate the number of bytes from the beginning of the module file to the first byte of a component of the module file, e.g., the component pointed to by the arrow in FIG. 2. Arrows on the right of the FIG. 2 show indices, e.g. pointers, to other components of the module. The components of the software module need not appear in any particular order, although it may be convenient to require the module header to be placed at the beginning of the module. It may also be convenient to place sections in the same “segment” (i.e., sharing the same access protections) contiguously. Accordingly, in FIG. 2, the components of the software module have been placed in a random order, except for the module header, which is located at the beginning of the software module, and the two data sections, which have been placed together. Thus, except for the segments, the relative order of the components in the example software module has no correlation with any logical relationships between the components.

The module header 310 may contain an index 311 to the first section in the section header table 330, an offset 312 to the program header table 320, and an offset 313 to the section header table 330. Skilled artisans will recognize that other fields may also be included in the module header.

The section string table 340 may contain strings which correspond to the names of particular sections in the software module.

Entry point table 350 may include a symbol index 351 that may reference an entry in the symbol table 390. The symbol index references a symbol in the symbol table that is allowed as an entry point in the software module, e.g., the symbol may represent an address where execution may begin in the software module when this address is invoked in a procedure call from outside the software module.

Data section 370 may contain data (variables) for the software module. The software module may have additional data section as needed. Although FIG. 2 shows two contiguous data sections, data sections in the software module need not be contiguous.

Text Section 360 may contain code or other text-related information for the software module. The software module may have additional text sections as needed.

Symbol Table 390 may contain symbol information for each symbol used in the software module. The symbol information may be stored in entries for each symbol used in the software module. Each entry may contain an index 391 pointing to the name of the symbol in the symbol string table 380, and an index 392 referencing the section header table entry corresponding to the section where the symbol's value is found.

The program header table 320, which is optional, may contain information describing the segments of the software module. The program header table may contain an entry for each segment in the software module (e.g., executable code, unprotected data sections, protected data sections). Each entry may contain an offset to the corresponding segment in the software module, although skilled practitioners will recognize that any other way of uniquely identifying and locating the corresponding segment could be used. For example, in the example software module shown in FIG. 1, the illustrated program offset 321 is the offset from the beginning of the software module to the single text section 360 which makes up the executable code segment in the example software module. Each entry in the program header table may also include some way of determining the extent of the segment, e.g., a field indicating the size of the segment or an offset to the last entry in the segment. Skilled artisans will recognize that the program header table may be modified to include additional segments or additional types of information.

The section header table 330 may contain section identification information, e.g., an entry corresponding to each section in the software module. Each entry in the section header table may contain one or more fields or sub-entries with information about the corresponding section in the software module. An entry in the section header table may include as a field a section header name index 331. The section header name index may be used to reference an entry in a section string table 340. The referenced entry in the section string table may be the name of the section corresponding to the entry in the section header table. An entry in the section header table may also include as a field a section header offset 332. The section header offset 332 may indicate the offset to the section corresponding to the entry in the section header table. For example, FIG. 1 shows a section header table entry corresponding to the first data section 370 shown in the figure; the section header table entry includes an offset to the first data section. An entry in the section header table may also include as a field a section header link 333. The section header link 333 may be used to reference the next entry in the section header table. Skilled artisans will recognize entries in the section header table 330 may also include additional fields.

Symbol String Table 380 may contain strings corresponding to the names of symbols used in the software module. The symbol string table may employ any conventional way of storing string data.

Relocation Information Table 395 may contain relocation information for the software module. Each use of a symbol in the software module may have a corresponding entry in the relocation information table. Each entry in the relocation information table may include one or more fields. An entry in the relocation information table may include a symbol identifier 396, which may be a reference to the symbol's entry in the software module's symbol table, a reference to the symbol's entry in the system symbol table, the name of the symbol, or other convenient means of uniquely identifying the symbol. An entry in the relocation information table may also include a section identifier 397, that identifies a section where the symbol is used. This identifier may be a reference to the section header table for the identified section, a pointer to the location where the identified section has been located in memory, or any other way of uniquely identifying the identified section. An entry in the relocation information table may also include symbol position offset 398 that identifies the position of the symbol within the section where the symbol is used. It will be appreciated that the section identifier can be used in combination with the symbol position offset 398 to determine the exact location in memory where the symbol is used. An entry in the relocation entry table may also include a reference type 399. The reference type may indicate whether the symbol is defined in the software module or outside the software module. The reference type may also indicate the way the symbol is used, e.g., direct reference, indirect reference, offset reference, etc. It will be appreciated that information on the way the symbol is used may alternatively be determined from information stored with the symbol reference in the section where the symbol is used, assuming compilation places that information with the symbol reference.

Skilled practitioners will also recognize that additional components may be added to the software module, e.g., additional text sections, additional types of data sections, etc. Skilled practitioners will also recognize that additional information added to the existing components.

The example software module has many backward references, and the order of the components of the example software module is not suitable for sequential processing of the example software module. For example, FIG. 2 shows the section header table 330 near the end of the example software module. Each entry in the section header table 330 may contain a reference to a section that appears earlier in the software module. The section header table entry may need to be read before information in the corresponding section can be loaded and linked, thus requiring either reading the software module nonsequentially, or requiring saving all of the sections in the linker/loader's memory during the linking/loading process.

It will be appreciated that, because the order of the components in a software module is not fixed, the same problem that arises with the backward references in the section header table in the example software module may also arise with other components of the software module that include indices or references.

Skilled practitioners will recognize that the present invention is not limited to use with particular language, file format, or even to the use of a compiler or compiled software modules.

Example Reordered Software Module

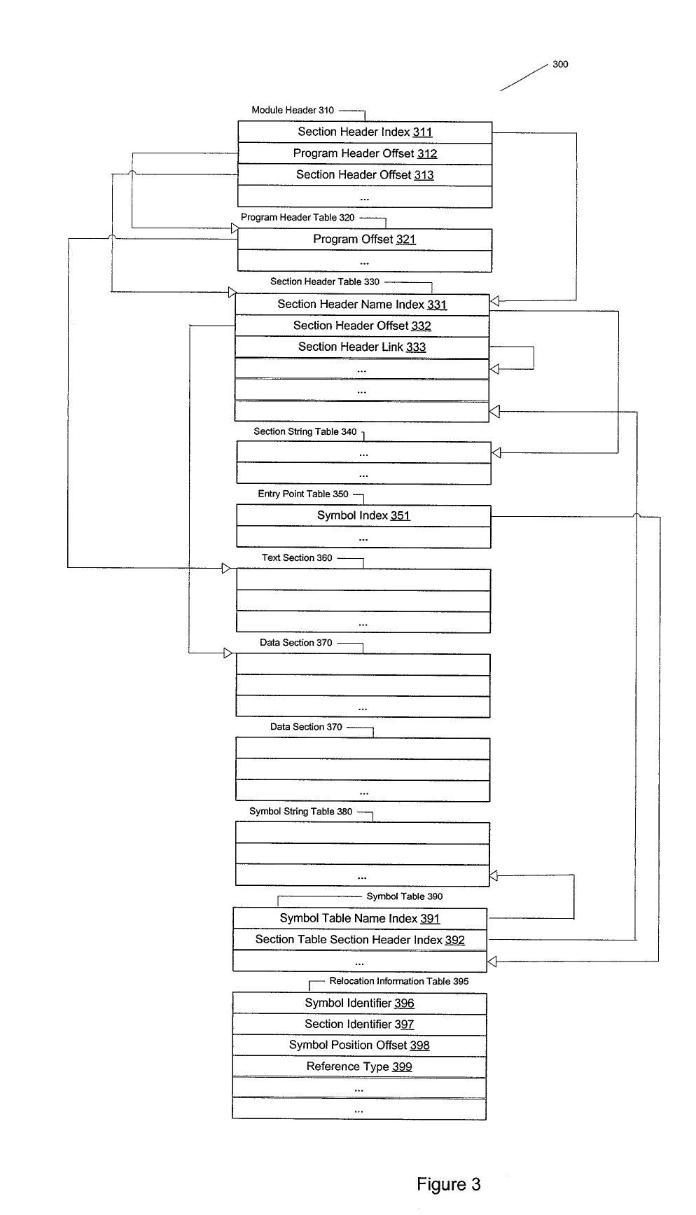

FIG. 3 illustrates an example software module 300 reordered according to the present invention. In the illustration of the example reordered software module, arrows on the left side of FIG. 3 show offsets in the module file. Arrows on the right of FIG. 3 show indices to other components of the module. The components of the reordered software module have the same basic definitions as the components illustrated in FIG. 2, except that the components are arranged in the software module in a pre-specified order. However, the offsets and indices in the example reordered software module have been adjusted to reflect the positions of the components of the reordered module. An example reordering procedure, described in further detail below, that includes adjusting the offsets and indices, may be used to transform a software module, e.g., the example software module of FIG. 2, into a reordered software module whose components are in a pre-specified order, e.g., the example software module in FIG. 3.

In the example reordered software module illustrated in FIG. 3, the module header 310 is the first component. A program header table 320 may follow the module header in the example reordered software module. A section header table 330 follows the program header table 320 in the example reordered software module. A section string table 340 may follow the section header table in the example reordered software module. An entry point table 350 may follow the section string table in the example reordered software module. A text section 360 may follow the entry point table in the reordered software module. One or more data sections 370 may follow the text section in the reordered software module. Symbol String Table 380 may immediately follow the last data section in the reordered software module. Symbol Table 390 may follow the string table in the example reordered software module. Relocation Information Table 395 may follow the symbol table in the example reordered software module. It may be convenient to place internal symbol relocation information table entries ahead of external symbol relocation information table entries within the relocation information table, or alternatively to include them as two separate tables.

It may be convenient to place symbol relocation information table entries for symbols defined within the software module ahead of symbol relocation information table entries for symbols defined outside the software module, or alternatively to include these two types of symbol relocation information table entries in two separate tables. It will be observed that the example reordered software module includes two types of backward references. In the example embodiment, the linker/loader may be built with knowledge of the few backward references that are used in the example reordered software module. The information referenced by the backward references may be saved in local memory by the linker/loader when the information is first read by the linker/loader. This saving of information avoids the need for nonsequential reading of software module while the software module is linked. At the same time, because the number of backward references has been limited in the reordered file, the amount of information that needs to be saved by the linker/loader remains relatively small.

The first set of backward references in the example reordered software module is to the symbol string table 380, which appears before the symbol table 390. In accordance with the example embodiment of the present invention, the symbol string table 380 is placed before the symbol table 390 because linker/loaders typically cannot efficiently process the symbols without already having access to the names of the symbols. It may often be more memory-efficient to save the symbol string table in memory before processing the symbol table, rather than processing the symbols first. If the symbol string table were located after the symbol table, then the symbol table may have to be saved in memory, before reading the symbol string table. The symbols may then be processed only after the symbol string table had been read, requiring saving the software module's entire symbol table in the linker/loader's memory.

The second set of backward reference in the example reordered software module is an index in the symbol table 390 referencing the section header table 330. There may be one of these backward references for each symbol in the symbol table. Linking may require going back and forth between the section header table and the symbol table, thus a reference in both direction may be needed. In the example embodiment described below, the loader saves section header information from the section header table 330 in local memory, avoiding nonsequential reading of the software module when the symbols are processed.

Skilled practitioners will appreciate that the software module may be further modified and/or reordered to eliminate even more backward references, or even to eliminate all backward references. However, in some instances, eliminating even more backward references may require greater code modifications with existing tools, and reduced compatibility with existing object code formats, increasing the cost of implementing and using the example embodiment of the invention.

Skilled practitioners will also recognize that additional backward references may be allowed in the reordered software module. However, if nonsequential reading of the reordered software module is to be avoided, allowing additional backward references may require more fields be stored in the linker/loader's local memory during the linking procedure.

Skilled practitioners will also recognize that additional components may be added to the reordered software module, as long as the number of additional backward references added is limited. A software module may include additional text sections, additional types of data section (e.g., separate data sections for initialized and uninitialized variables, separate data sections for read-only variables, etc.). Other fields may be added to the software module as well, such as fields dealing with read, write, and execution access protections. Furthermore, it will also be appreciated that other possible arrangements of the software module may be possible, provided they have a limited number of backward references.

Skilled practitioners will also recognize that the example reordered software module may still be in a format where it can be processed by a standard linker/loader, although such a standard linker/loader may not be able to take advantage of the reordering of the example software module.

Example Reordering Procedure

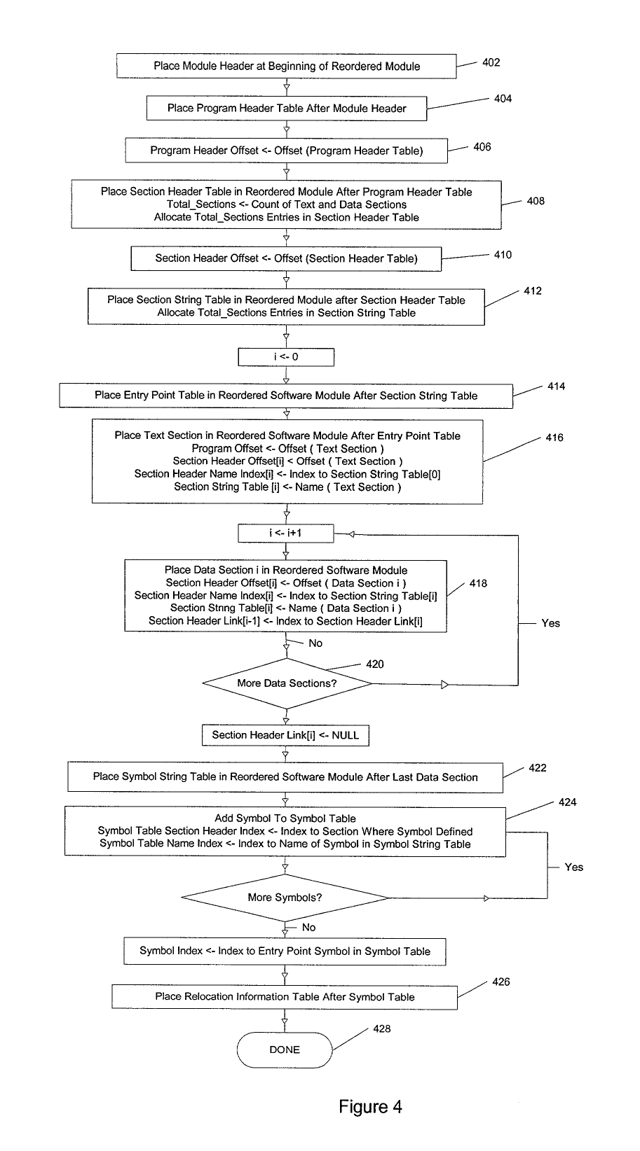

FIG. 4 illustrates a detailed flowchart for the example software module reordering procedure corresponding to step 104 in FIG. 1. Skilled practitioners will recognize that other procedures may be used to produce the example reordered software module, e.g., a compiler may be altered to directly generate a software module in the correct format. Skilled practitioners will also recognize that this procedure may be performed by a separate program, e.g., a stand-alone reordering module, or as one or more modules contained in another software tool in the computing environment. Skilled practitioners will also recognize that any conventional way of obtaining the software module may be used to receive the software module for reordering, e.g., the entire software module may be read into local memory used in the reordering procedure, a reordering module may read the software module from an I/O device, the software module may be passed as an output stream from a compiler to a reorder module or other software tool including the reordering procedure, etc. The example procedure illustrated in FIG. 4 could be implemented as a set of instructions adapted to be executed by a processor and stored on any convention computer-readable medium. When executed, the instructions would define a series of steps to be used to carry out the example procedure.

In step 402, the software module header for the reordered module may be copied to the beginning of the reordered module. It will be appreciated that the reordered module may be saved in memory during the reordering procedure or, alternatively saved on a secondary storage system with sufficient referencing functionality to support to the re-ordering procedure.

In step 404, the program header table may be copied into the reordered software module following the module header.

In step 406, the program header offset contained in the module header may be adjusted to reflect the offset to the program header table in the reordered software module. The offset may be determined by computing the relative memory address difference between a base address, e.g., the memory address of the beginning of the module, and the memory address at the beginning of the program header table. It will be appreciated that any other consistently-used procedure of determining memory offsets may be used.

In step 408, the section header table may be copied into the reordered module immediately following the program header table. Space may be allocated in the section header table to contain section header entries for each section in the software module. In the example embodiment, the number of sections is the number of text and data sections, and at least three fields are used in the section header table for each section. It will be appreciated that the procedure may be adapted if other sections, e.g., multiple text sections, or new types of section were added to the software module

In step 410, the section header offset, located in the module header, may be adjusted to indicate the offset to the beginning of the section header table in the reordered software module.

In step 412, the section string table may be placed in the reordered software module immediately following the section header table. At least one entry is allocated in the section string table for each section. It will be appreciated that the size and nature of an entry in the section string table will depend on how strings are implemented in the system. Any conventional procedure for implementing strings may be employed.

In step 414, the entry point table may be placed in the reordered software module immediately following the section string table.

In step 416, the text section may be placed in the reordered software module immediately following the entry point table. If the text section is the beginning of a segment, the program offset in the corresponding entry in the program header table may be adjusted to reflect the offset to the beginning of the text section. The section header offset in the section header table entry corresponding to the text section may be adjusted to reflect the offset to the beginning of the text section. The section header name index corresponding to the text section in the section header table may be adjusted to reference the corresponding entry in the section string table in the reordered software module. The name of the text section may be stored in the corresponding entry in the section string table.

In step 418, a data section may be placed in the reordered software module immediately following the preceding text or data section. The section header offset in the section header table entry corresponding to the data section may be adjusted to reflect the offset to the beginning of the data section. The section header name index corresponding to the data section in the section header table may be adjusted to reference the corresponding entry in the section string table in the reordered software module. The name of the data section may be stored in the corresponding entry in the section string table. The section header link index in the section header table entry for the section processed preceding the data section is adjusted to reference the section header table entry for the data section. Finally, if the data section is the first section in a segment, the corresponding entry in the program header table may be adjusted to reflect the section's new position in the reordered software module.

In step 420, step 418 may be repeated once for each data section in the reordered software module.

In step 422, the symbol string table may be placed immediately after the last data section in the reordered software module.

In step 424, the symbol table may be placed immediately after the symbol string table in the reordered software module. The symbol indices in the entry point table may be adjusted to reference symbols in the symbol table that are entry points in the reordered software module. For each entry in the symbol table, the section table section header index in each entry of the symbol table may be adjusted to reference the section header of the section in the reordered software module where the symbol value is located. For each entry in the symbol table, the symbol table name index is adjusted to reference the corresponding entry in the symbol string table in the reordered software module.

In step 426, the relocation information table for the software module may be placed immediately after the symbol table in the reordered software module. If relocation and symbol resolution are performed as separate steps by the linker/loader, it may be convenient to place relocation information table entries for symbols defined with the software module ahead of relocation information table entries for symbols defined outside the software module. Depending on the implementation of the linker/loader, it may also be convenient to update entries in the relocation information table to reflect the reordered position of the section header table entry for the section containing the corresponding symbol reference, to update information about the location of the corresponding symbol in the software module symbol table, and/or to update other referencing information contained in the relocation information table entry that needs to be changed because the software module is reordered.

In step 428, the reordering operation is complete, and the reordered software module may then be transferred to the target system, or saved until needed.

It will be appreciated that other types of components may be included in the software module, and that the example reordering procedure may be readily modified to include steps to properly reorder a software module that includes such additional components. Furthermore, the example procedure of placing the existing components contiguous to each other may be altered, e.g., by allowing additional free space or by inserting other components in the software module between existing components, provided that indices and offsets are properly adjusted to reflect alterations to the format of the software module, and provided that sections in the same segment remain contiguous. Separating segments may require additional modification of the program header table.

It will also be appreciated that other equivalent procedures may be used to produce the reordered software module, e.g., allocating all required space and determining relative references before copying the components into the reordered module, or directly generating the reordered module in the compiler instead of using a separate reordering tool, or other variations on the procedure.

Example Loading and Linking Procedure

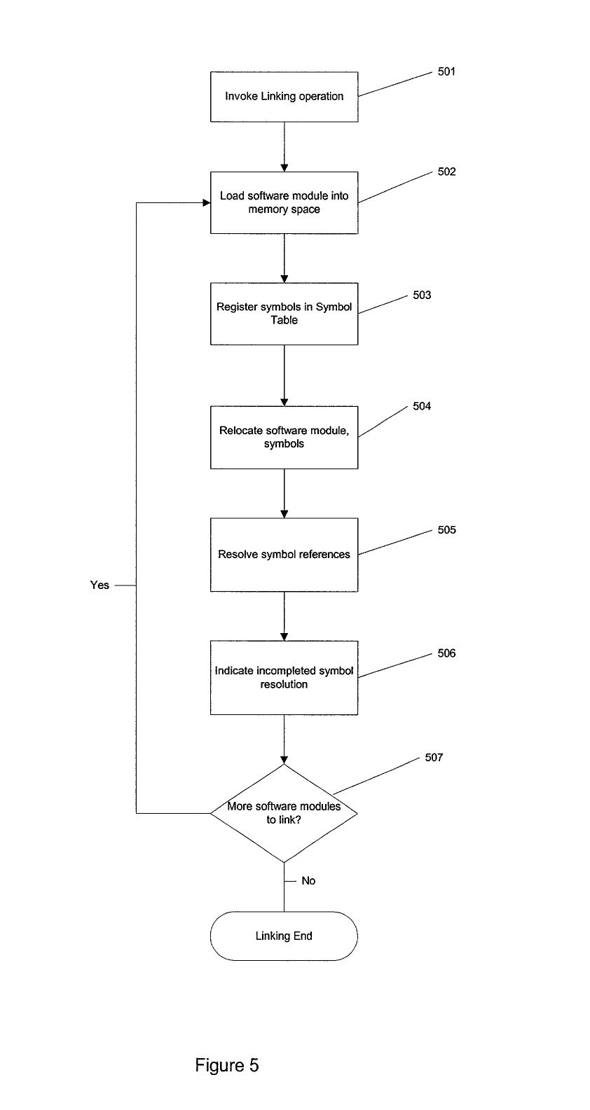

FIG. 5 shows a flow chart of an example loading and linking procedure according to the present invention. The example loading and linking procedure may be used to load and link one or more software modules to form a single function unit (e.g., an application). The software modules may include processor instructions, data structures, memory mapped I/O locations, and/or other elements employed in typical software implementations.

In the present example embodiment, the loading/linking application may comprise both the loading of software modules into a memory space of the computing environment and the linking of software modules together, although these operations may also be performed by separate “linker” and “loader” applications, as is conventional. The example procedure may be performed by a “linker/loader”, or by other applications in a computing environment. The example procedure illustrated in FIG. 5 could be implemented as a set of instructions adapted to be executed by a processor and stored on any convention computer-readable medium. When executed, the instructions would define a series of steps to be used to carry out the example procedure.

In step 501, the example loading and linking procedure is invoked, for example, by issuing a command to execute the linker/loader. The invocation may identify the particular software module(s) to be linked, or the identity of software modules to be linked may be based on their presence in a known location (e.g., a particular file directory). Other identification procedures are also possible. The software modules may be stored in a secondary storage system to which the linker/loader has access.

In step 502, a software module to be linked is loaded into a memory space. The software module may be located in a portion of the memory space (the portion need not be contiguous) that may be identified by a set of memory addresses. The memory addresses may be grouped, such that each grouping may be represented by a “base address” that can be applied to determine an actual location for a section of the software module in the portion of the memory space. For example, the software module may be loaded such that one of its sections is located in one area of memory (having a “first” base address) and another of its sections is located in a second area of memory (having a “second” base address). The identity of each software module loaded into the memory space and the location where each software module section is loaded may be maintained by the linker/loader (or by the operating system).

In step 503, symbols defined in the software module are registered in a system symbol table, which may be maintained by the linker/loader application (or the operating system) in order to track the use of symbols by software modules. Each software module may define one or more symbols to allow other software modules to access certain locations in the software module (for example a data structure that may be shared or a library function that may be called). These symbols may be presented as a list of symbol definitions—for example symbol name and associated value—in the software module for use by the linker/loader.

In step 504, relative references in the software module are “relocated” according to the location of the software module in the memory space. Memory references in each section of the software module may be initially specified relative to a zero address (for the start of each section) prior to loading into memory. Upon loading into the memory space, these memory references may be adjusted to match the actual addresses of the referenced elements in the memory space. As mentioned previously, each area of memory into which a section of the software module has been loaded may be represented by a base address. Memory references may be adjusted, for example, by adding the appropriate base address to the memory reference value. The symbol values for symbols defined by the software module are also relocated by applying the appropriate base address to the (unrelocated) symbol value.

In step 505, symbol references in the software module are resolved. As described above, instructions in software modules may contain references to memory locations external to the software module. These external references may be denoted by symbols in the software module that allow a linkage to the external memory location. The linker/loader parses the software module to obtain the symbol references used in the software module. Where a symbol reference is found in a software module, the symbol reference is resolved by determining the symbol's value from the symbol's entry in the system symbol table. Any instructions in the software module that use the symbol reference may then be changed based on the symbol value—e.g., the symbol value may be inserted into the instruction.

In step 506, if any one of the symbol references in the software module has not been resolved, the linking procedure for the software module may be indicated to be incomplete. This indication may take several forms: the linker/loader may generate a message for display, indicating that the linking procedure did not complete; the linker/loader may also record that the software module is incompletely linked. This recorded information may be used by other utilities present in the computing environment in order to obtain status information concerning the loading and linking procedure.

In step 507, whether there are any software modules remaining to be linked is determined. The invocation of the linker/loader may specify a list of software modules to be linked, for example, by a command line instruction to the linker/loader, by a particular location storing the software modules, or by the contents of the software modules themselves. If further software modules need to be linked, steps 502-507 are performed for each software module. When all software modules have been linked, the functional unit is complete, and can be used as desired.

Example Load Procedure

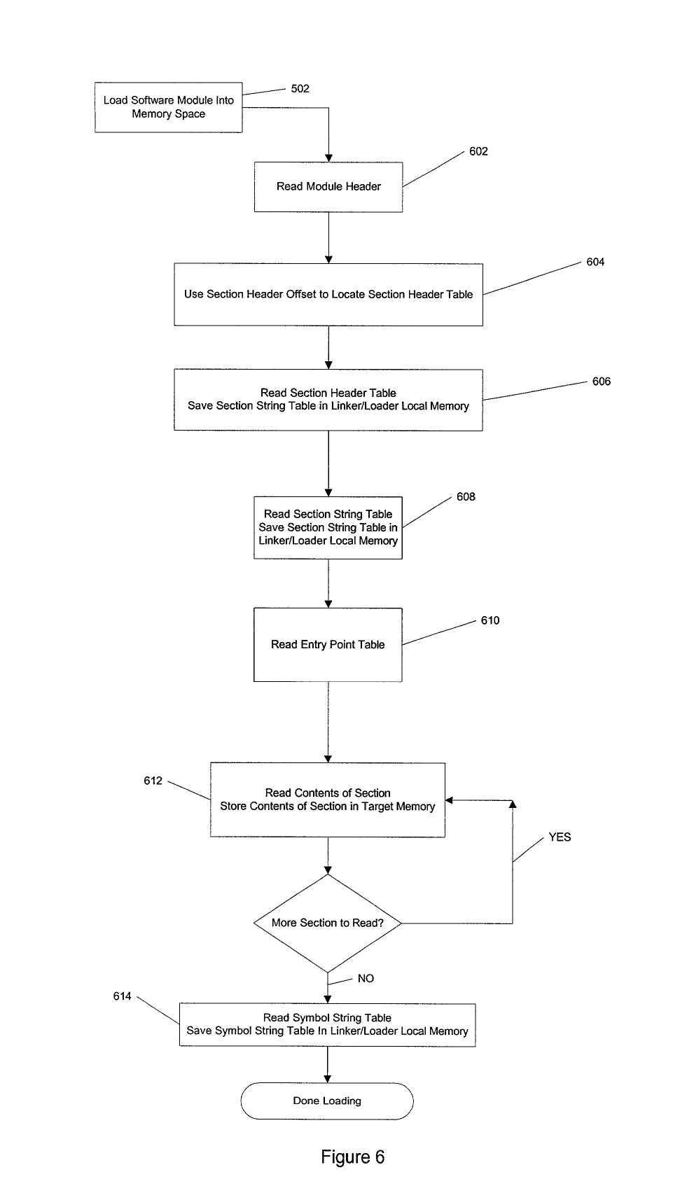

FIG. 6 illustrates a flowchart of an example load procedure, according to the present invention, that may be used in step 502 of FIG. 5. It will be appreciated that all reading in the example load procedure may be performed sequentially; no backward references are followed in reading the software module. The load procedure may be performed by the linker/loader, by a separate loader, or by other tools in an operating system or software development environment.

In step 602, the module header of a software module to be loaded and linked may be read. Optionally, the program header offset found in the module header may be used to locate the program header table in the software module, e.g., by adding the offset to the base address for the software module. The program header table may be read, stored, and or used as needed. The program header table is not specifically required for loading or linking in the example embodiment, but the information may be used for other purposes by the linker/loader or by other tools in the operating system or software development environment, e.g., to commence actual execution of a linked application.

In step 604, the section header offset found in the module header may be used to locate the section header table in the software module, e.g., by combining the offset found in the section header table with the base address for the software module.

In step 606, the section header table may be read. Information from the section header table may be saved in the local memory of the linker/loader for use later in the load and link procedure.

In step 608, the section string table, which may be positioned in a reordered software module immediately follow the section header table, may be read. The section string table may also be saved in the local memory of the linker/loader for use later in the load and link procedure.

In step 610, the entry point table may be read. Depending on the implementation, the entry point table may also be saved in the local memory of the linker/loader.

In step 612, a section may be located in the software module, e.g., by using the offset in the section header table, which was saved in the local memory of the linker/loader. The entire contents of the located section may be read by the linker/loader and stored in the target memory. It will be appreciated that the section may be read and written to the target memory in different possible sequences; e.g., one symbol or one instruction at a time may be read and then written to the target memory, the entire section may be read and then the entire section written to the target memory, or the section may be read and written in intermediate-sized chunks.

Information about the location in the target memory where the section is loaded may be saved either in the section header table, or elsewhere in the local memory of linker/loader, or in any other suitable pre-determined location. For example, the linker/loader may store the identity of each loaded software module and the locations where each section are stored in a software module list data structure.

Step 612 is repeated until all sections have been read. It will be appreciated that all sections need not be actually read and written to target memory; e.g., sections that are not needed may be marked with a flag by the compiler and skipped by the linker/loader.

In step 614, after all sections have been read, the symbol string table may be read and saved in the local memory of the linker/loader.

Example Symbol Registration Procedure

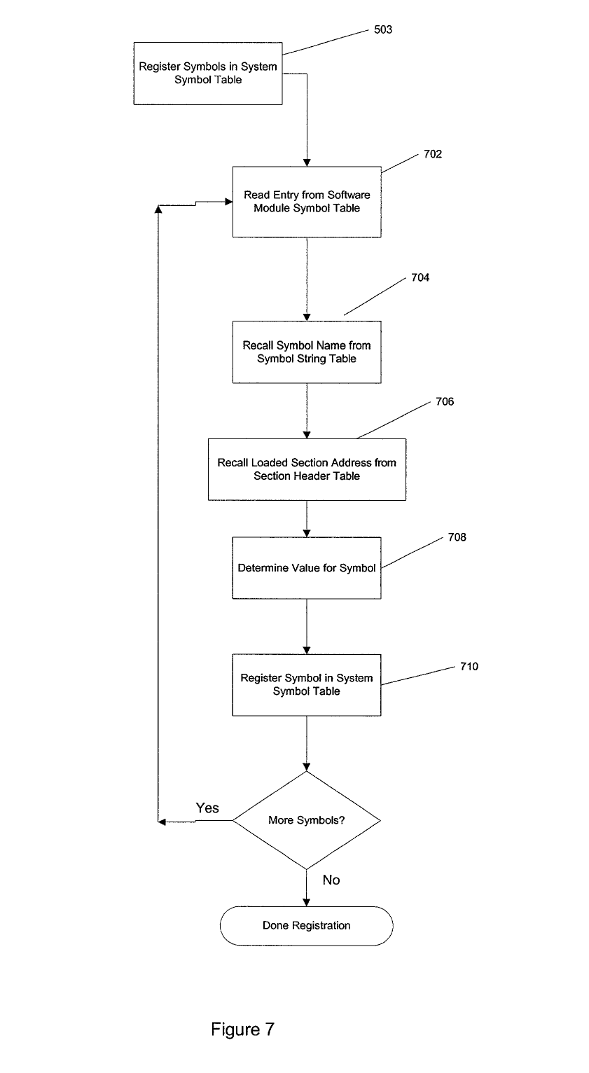

FIG. 7 illustrates an example symbol registration procedure, according to the present invention, that may be used in step 503 of FIG. 5. Symbols defined in the software module may be registered in a system symbol table. Registration allows the linker/loader application, the operating system, or other applications in the computer system environment to track the use of symbols by software modules. Each software module may define one or more symbols to allow other software modules to access certain locations in the software module (for example a data structure that may be shared or a library function that may be called). If these symbols are presented as a list of symbol definitions in a software module—for example symbol name and associated value—registration may be used to copy these symbol values to the system symbol table for use by other software modules or applications.

In step 702, an entry may be read from the software module's symbol table.

In step 704, the name of the symbol may be determined by referencing the symbol string table, using the symbol table name index reference in the symbol's entry in the symbol table entry. In the example load process described above, the symbol string table is saved in the linker/loader's local memory, so no nonsequential reading of the software module is required to obtain the symbol name from the symbol string table.

In step 706, the section table section header index in the symbol's entry in the symbol table may be used in order to reference the section header table of the section where the symbol is installed.

In step 708, the symbol's value may be determined. Information from the section header referenced in step 706, may be used to determine the address of the symbol's section. Alternatively, this information may be saved in local memory by the linker/loader when the section is loaded in memory, e.g., in a software module list data structure. The relative position of the symbol in the section may be obtained by any suitable means, e.g., the relative position may be stored in the software module's symbol table by the compiler, or recorded while loading the section in memory. The position of the symbol in the section may be combined with the address of the symbol's section, e.g., by adding memory offsets, to determine the value of the symbol. The symbol value may be stored in the symbol table, and/or in the local memory of the linker/loader.

In step 710, the symbol may be registered in the system symbol table. An entry giving the name of the symbol, an identifier of the software module defining the symbol, and the symbol's value may be added to the system symbol table. This information may then be used when references to the symbol from the software module, or from other software modules, are resolved.

Steps 702-710 may be repeated for each symbol in the reordered software module's symbol table. When all the symbol's have been registered, symbol and module relocation may begin.

Example Relocation Procedure

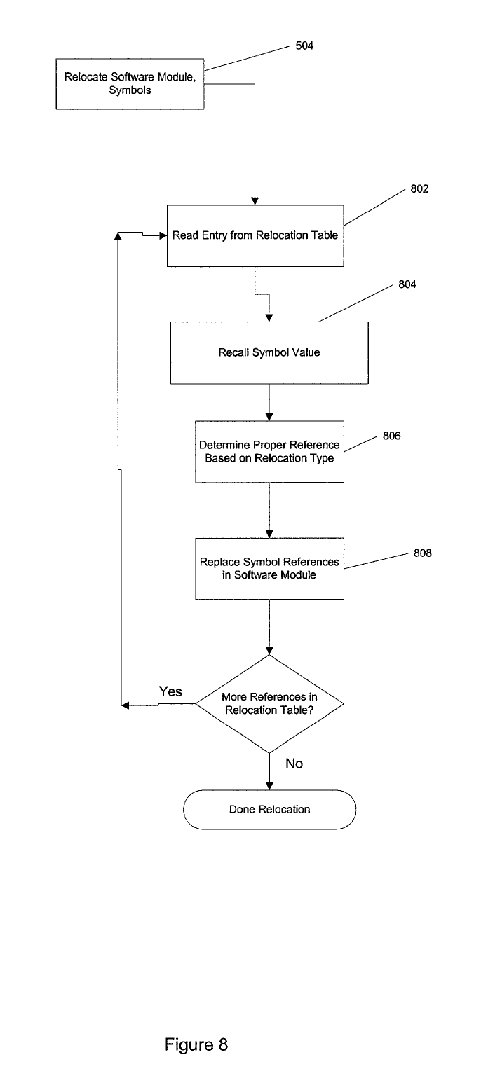

FIG. 8, illustrates an example module and symbol relocation procedure, according to the present invention. Relocation is a procedure for updating the values of references in the loaded software module to match the actual addresses of other referenced elements of the software module. As mentioned previously, each area of memory into which a section of the software module has been loaded may be represented by a base address. Memory references in each section of the software module may be initially specified relative to a zero address (for the start of each section) prior to loading into memory. Memory references may be adjusted, for example, by adding the appropriate base address to the memory reference value. Symbol values for symbols defined by the software module are also relocated by applying the appropriate base address to the (unrelocated) symbol value.

The example relocation procedure may be used in step 504 of FIG. 5. It may be desirable to separate the relocation process for symbols defined in the reordered software module from the resolution process for symbols defined outside the reordered software module. Accordingly, this relocation procedure is described in the example embodiment as a separate step from symbol resolution. Skilled practitioners will recognize that these two steps may be combined in a single step, provided that a flag in the relocation information table, or other means, is used to determine whether an entry in the relocation information table references a symbol defined within the software module being relocated, or a symbol defined outside the software module.

In step 802, an entry may be read from the relocation information table of the reordered software module.

In step 804, the value of the symbol in the relocation information table entry read in step 802 is recalled, e.g., by looking up the value in the system symbol table. Alternatively, symbols from the reordered software module may have had their values saved locally, either in the local memory, or in the reordered software module's symbol table. Relocation in step 804 may be restricted to only symbols defined in the software module, in which case references to symbols outside the software module may be flagged for resolution to a reference outside the software module in the symbol resolution step, e.g., by including an appropriate field in the relocation information table. Information about unresolved symbols references (e.g., the software module making the reference, the symbol referenced, and the location of the reference) may be maintained by the linker/loader in a link status information data structure.

In step 806, the type of reference to the symbol is determined. The reference type may be indicated by an entry in the relocation information table. Alternatively, the reference may be determined by examining the context of the reference. The reference type may be used to determine how the value of the symbol should be adjusted before changing the reference to the symbol in the software module, e.g., a direct reference may be unaltered, while a reference using an offset may be adjusted to reflect the offset.

Using information about the type of reference, and the value of the symbol, the proper reference address for the relocated reference may be determined. For example, if the reference is an offset reference, the specified offset to the symbol may be added to the value of the symbol.

In step 808, the reference to the symbol is linked, i.e., the reference in the loaded software module is changed to reflect the proper reference address that was determined in step 806. An entry may also be made in the reference data structure for the symbol, identifying the software module and location of the symbol reference which allows later re-linking of the software module.

Steps 802-808 may be repeated for each entry in the relocation information table corresponding to a symbol defined within the reordered software module.

If the relocation and resolution steps are performed separately, it may be convenient for the compiler or the reordering procedure described previously to place internal symbol relocation information table entries ahead of external symbol relocation information table entries. Alternatively, it may be useful to flag the relocation information table entry to indicate whether the corresponding symbol reference is to an internal or external symbol. This flagging may be performed by the compiler when the relocation information table is first created, or may be performed during the relocation procedure, e.g., flagging references where the symbol definition is not found in the software module for resolution.

Example Symbol Resolution Procedure

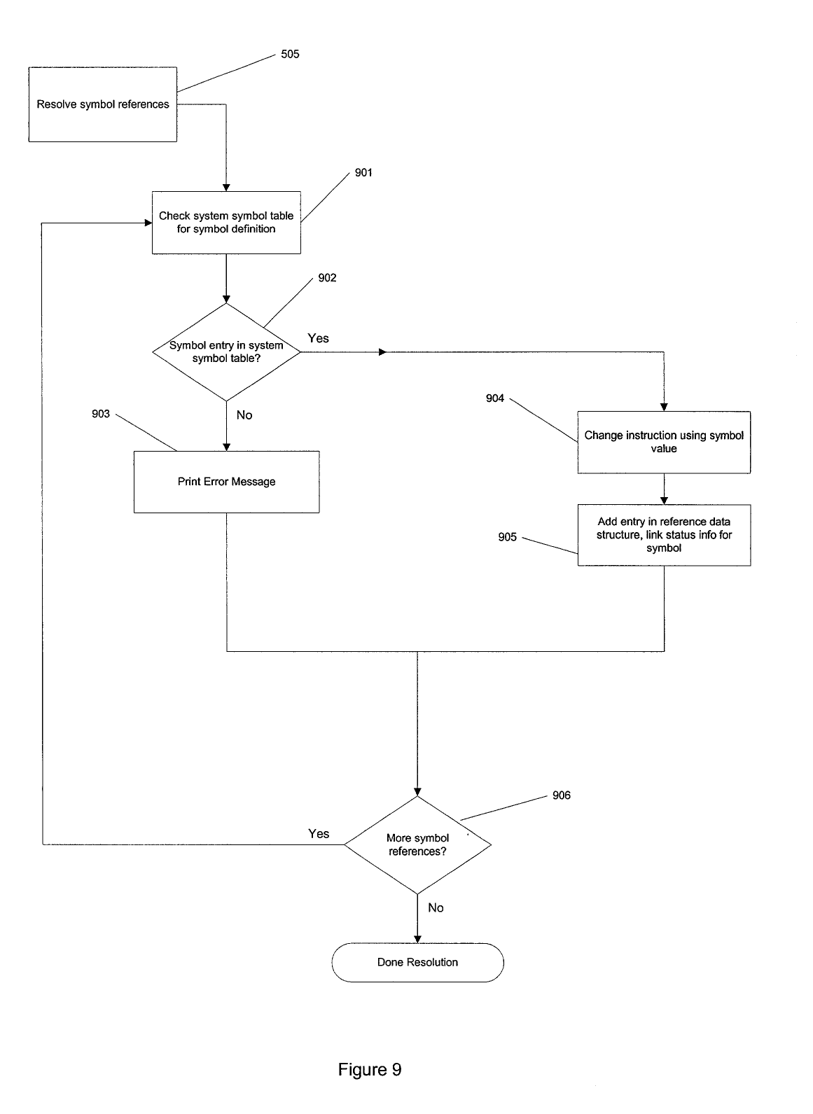

An example symbol resolution procedure that may be used in step 505 of FIG. 5 is illustrated in FIG. 9. As described above, instructions in software modules may contain references to memory locations external to the software module. These external references may be denoted by symbols in the software module that allow a linkage to the external memory location. Where a symbol reference is found in a software module, the symbol reference may be replaced by a correct reference to an actual location in memory.

Typically, information on the occurrence of each symbol reference in the reordered software module may be generated by the compiler, e.g., by parsing the software module, and storing the symbol occurrence information in the relocation information table.

In step 901, a symbol reference may be located by reading the reordered software module's relocation information table.

In step 902, the referenced symbol's value may be determined by locating the referenced symbol's entry in the system symbol table.

If the symbol is not found in the system symbol table (step 903), an error message is printed. Alternatively, the symbol may be assigned a default address —for example, a predetermined memory address which is otherwise inaccessible (i.e., invalid), and may therefore cause an error if it were accessed during execution. Thus, when a symbol cannot be correctly resolved, instructions using the symbol are set to the default address, which will cause an error condition when the instruction reference is executed.

If the symbol is already defined, the value associated with the symbol is retrieved from the system symbol table and used to update the symbol reference to the reflect the symbol's value (step 904). The value for the updated symbol reference may depend both on the symbol's value and on the type of reference being made to the symbol, e.g., direct, indirect, offset reference, etc.

An entry may also be made in the reference data structure for the symbol, identifying the software module and location of the symbol reference (step 905), which allows later re-linking of the software module. The reference information table may be maintained by the linker/loader, or by the operating system or other application in the computing environment. Maintaining the information in the reference information table may facilitate unloading or unlinking software in a dynamic environment.

Additional symbol references may be read from the relocation information table, until all symbol references have been processed (step 906).

By using the resolution procedure described above, no “dangling” references are produced, since all instructions using unresolved symbol references are set to the default address. Thus, if these symbol references remain unresolved, execution of the instruction using the symbol reference will cause a defined error condition (e.g., a memory fault), which can be appropriately handled by the operating system (e.g., the task executing the offending instruction may be shut down).

Skilled artisans will appreciate that a resolution procedure may be combined with the preceding relocation procedure, i.e., each symbol reference read from the relocation information table, and then replaced by an actual memory reference based on information from the system symbol table, whether the symbol was defined in the software module or outside the software module.

Example Linker/Loader

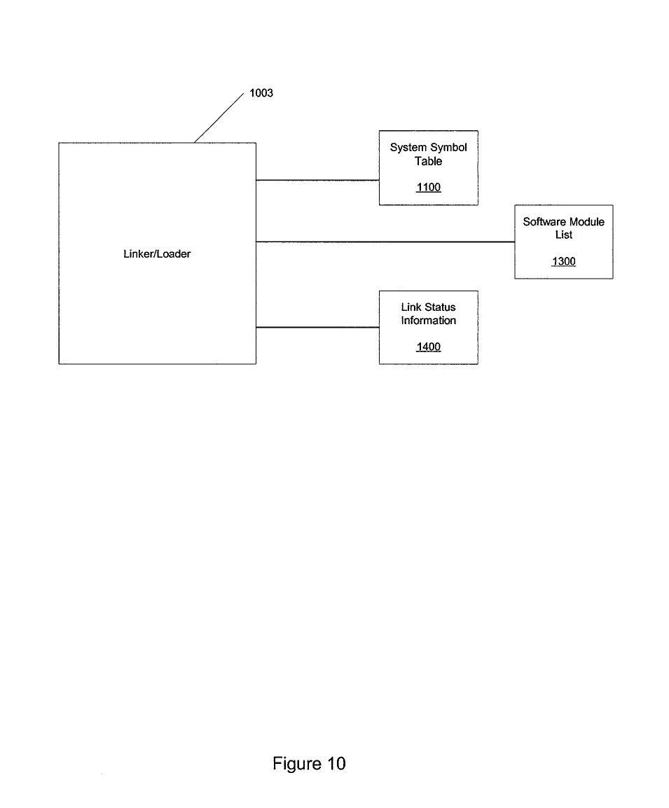

FIG. 10 illustrates an example linker/loader implemented according to the present invention. The example linker/loader 1003 may use several data structures in order to carry out a loading and linking procedure. The data structures used by the linker/loader 1003 may include, for example, a system symbol table 1100 that includes a list of the symbols used by software modules, the symbols' values, and the modules defining the symbols. The data structures used by the linker/loader 1003 may also include a reference data structure that may be contained in or referenced by the system symbol table; this reference data structure may include a list of references made in each software module using each symbol, and the references location within the software module. The data structures used by the linker/loader 1003 may also include a software module list data structure 1300; the software module list 1300 may contain entries to identify where sections of loaded software modules are actually loaded in memory. The data structures used by the linker/loader may also include a link status information table 1400; the link status information table may include entries that identify whether symbol references in loaded software modules have completely resolved. These data structures may all be maintained by the linker/loader 1003 or, alternatively, by the operating system or other application in the computing environment. The linker/loader may access all of these data structures during a load and link procedure, as was previously described.

Skilled practitioners will recognize that it may be advantageous to include other information in the linker/loader data structures or to employ other data structures as well. In addition, it will be recognized that different means may be used to implement the data structures used by the linker loader, e.g., a heap, a hash table, a linked list, etc.

Example System Symbol Table

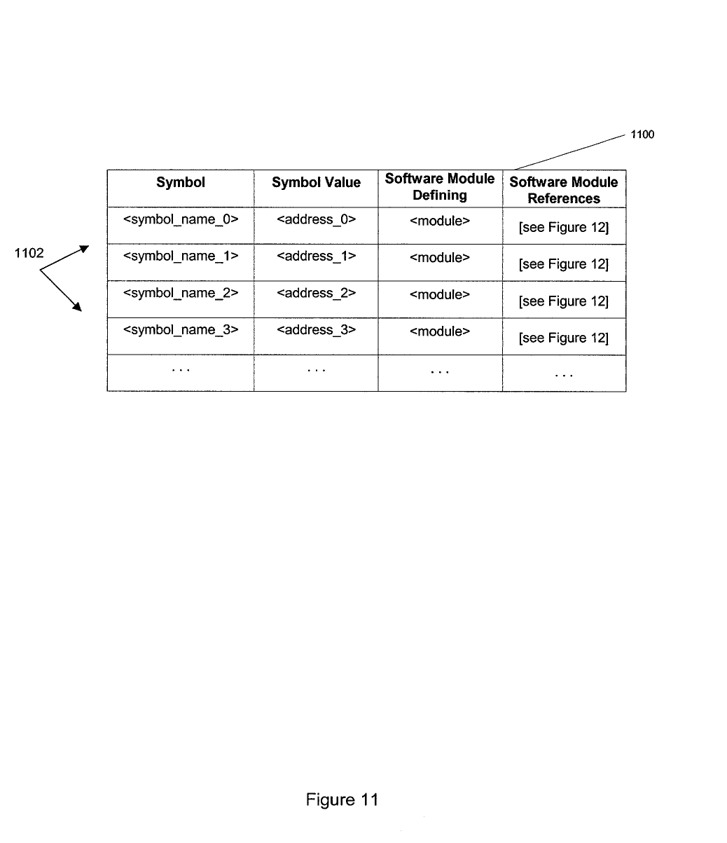

FIG. 11 illustrates an example system symbol table 1100, which may be provided as part of the example embodiment according to the present invention. The example system symbol table 1100 may be maintained by a linker/loader application, or by the operating system or other applications in the computing environment. Each software module to be linked may define one or more symbols to allow other software modules to access certain locations in the software module (for example, a data structure that may be shared or a library function that may be called). These symbols may be presented as a list of symbol definitions 1102 in the system symbol table.

Each entry 1102 in the system symbol table may contain one or more fields, each field providing information related to the corresponding symbol. In the example system symbol table, each entry may contain the name of the corresponding symbol. The name of the symbol may be stored as a link to a string stored in a string table, although other procedures for storing the symbol name may be used. The symbol table entry may also contain a value for the symbol, i.e., an address for the location in memory that the symbol is defined to represent. Initially, the symbol's value is set by the software module that defines the symbol. The system symbol table entry may also include information identifying the software modules which reference the symbol and information related to these references; in the example system symbol table a reference data structure 1200 indicates which software modules reference the symbol.

It will be appreciated that, although the example system symbol table is illustrated as a table, it may be stored in any suitable data structure, e.g., a heap, a linked list, a hash table, etc. It will also be appreciated that system symbol table entries may be stored as links to data structures containing information, rather than simply by storing the information directly in the symbol table. For example, the software module defining a symbol may be identified by a link to the software module, or by a link to an entry corresponding to that software module in a table of software module information. The reference data structure 1200 indicating which software modules reference the symbol need not be stored inside the system symbol table, but may be accessed using links, or other conventional means of associating the reference data structure with the corresponding symbol table entry.

The system symbol table may also be modified to include additional entries related to the symbols, e.g., the symbol's type, an entry indicating whether or not the symbol has been linked, access-control information or permissions related to the symbol, or other fields as desired.

Example Reference Data Structure

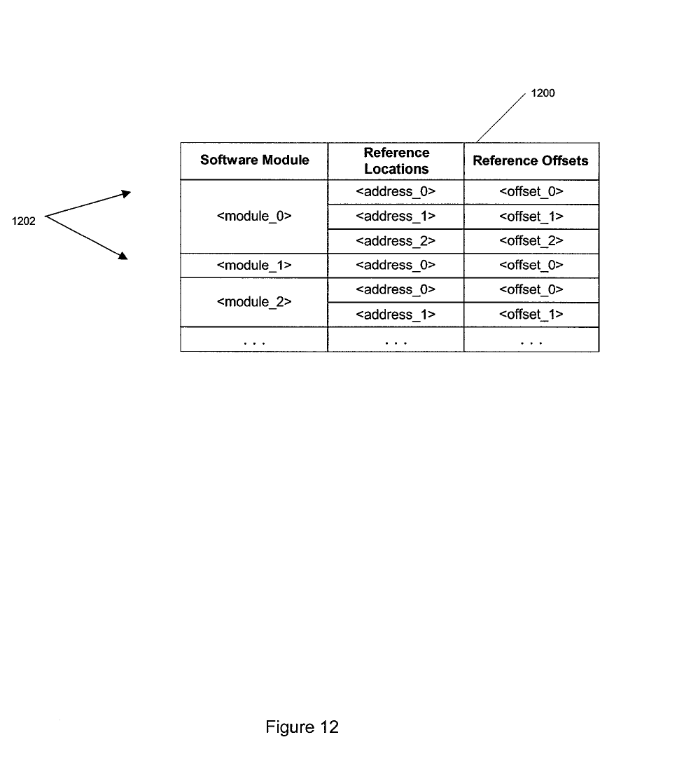

FIG. 12 illustrates an example reference data structure 1200. This data structure may be created for each system symbol table entry 1102 in the system symbol table 1100. The reference data structure may contain one entry 1202 for each software module that reference a particular symbol. Each entry 1202 may also contain a subentry for each reference in the software module to the particular symbol, the sub-entry containing a field indicating the location of the reference in the software module, information about the type of reference, or other information useful in the loading/linking procedure.

It will also be appreciated that, although the example reference data structure is illustrated as a table, it may be stored in any suitable data structure, e.g., a heap, a hash table, a linked list, etc. The example reference data structure may be physically stored in the system symbol table 1100, or alternatively, may be logically linked to the system symbol table.

Example Software Module List Data Structure

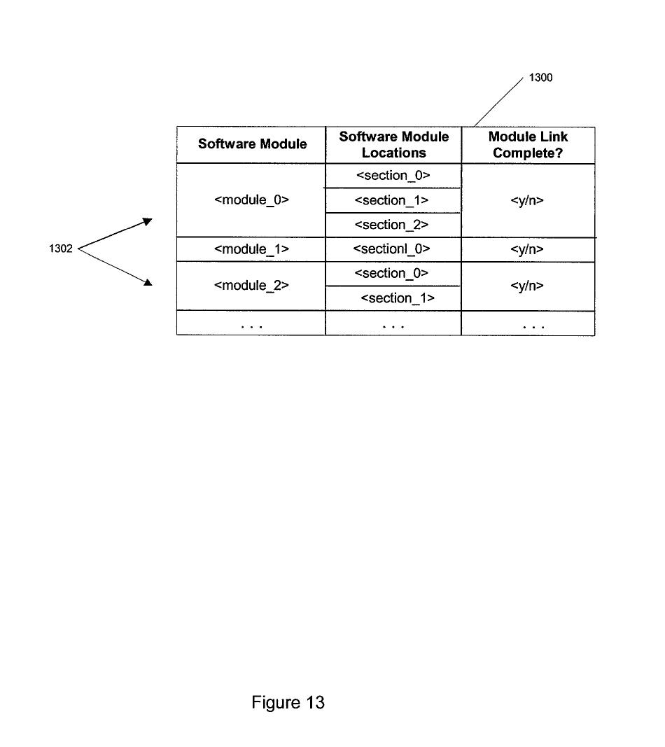

FIG. 13 illustrates an example software module list data structure 1300, according to the present invention. The identity of each software module loaded into the memory space may be maintained by the linker (or by the operating system) in a software module list data structure. The example link status information data structure may include entries 1302 for each software module. The software module list may include the name (or other unique identifier) of each software module that is loaded into the memory space, as well as the memory locations used by each section of the software module. The software module list data structure may also be used for storing indications of incomplete software module linking. Each entry may include an indicator, e.g., a flag, to indicate whether the software module has been completely linked, i.e., all the symbol references in the module have been resolved. Other information may also be stored in the software module list.

The software module list data structure may be used, for example, prior to execution of an application being linked to ensure that the loading and linking procedures have been successfully completed. The software module list data structure may also be accessed by other utilities present in computing environment (for example, software development tools) to obtain status information concerning the loading and linking procedure.

Link Status Information Data Structure

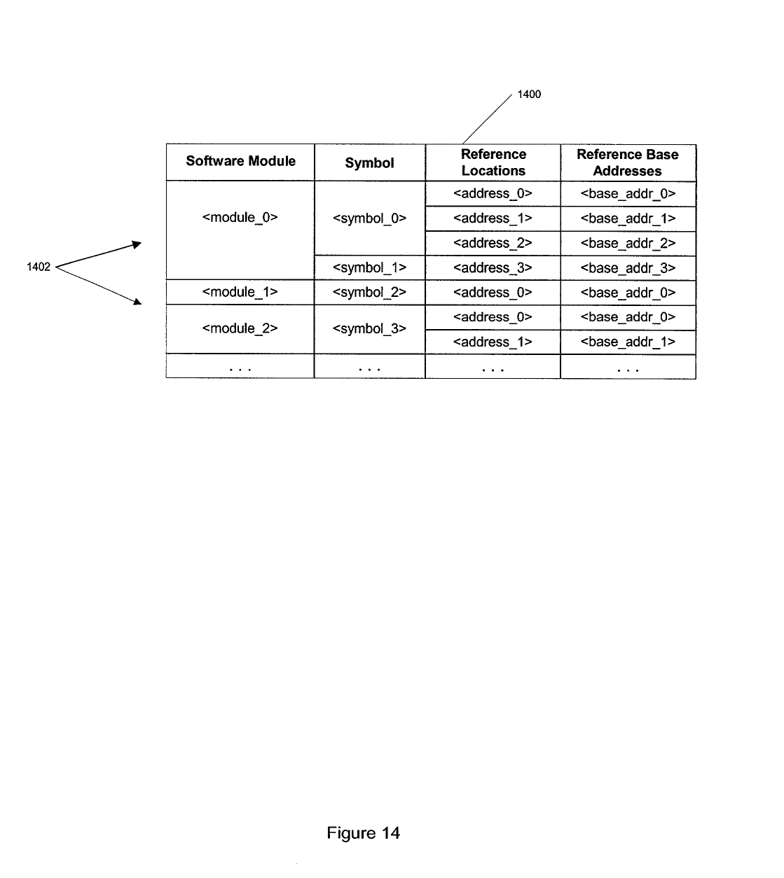

FIG. 14 illustrates an example link status information data structure, according to the present invention. Each entry 1402 in the link status information data structure may correspond to a software module that is to be loaded into the memory space and linked. Each entry 1402 may include fields, for example, an identifier for the corresponding software module (e.g., the software modules name, or a link to the software module). Each entry in the link status information data structure may include fields for each symbol used in the software module, or for each unresolved symbol in the software module. Each entry in link status information data structure may also include one or more fields that indicate where the symbol reference is made in the software module (e.g., the relative address of the symbol reference in a section, and the base address for the section.) Skilled practitioners will appreciate that other information may also be stored in the link status information data structure. It will also be appreciated that other conventional data structures besides a list or table, e.g., a heap, a hash table, etc., may be used in implementing the software module list data structure.

Example Target Computer System

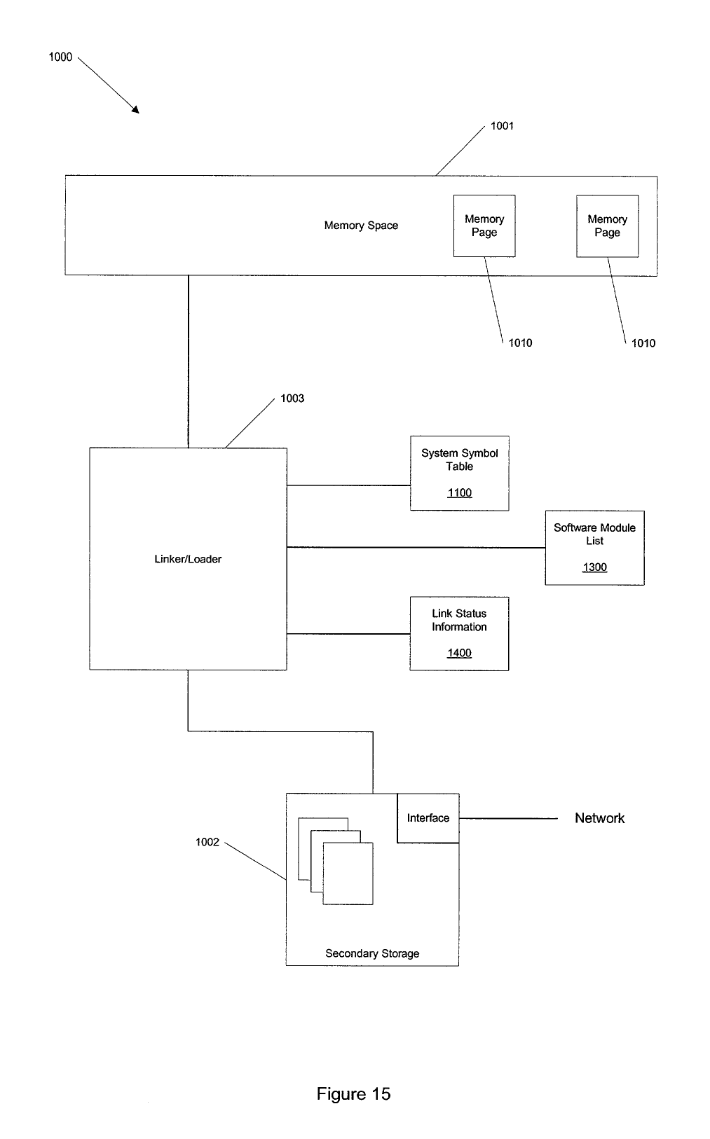

FIG. 15 illustrates a computer system 1000 according to the example embodiment of the present invention. The computer system includes a memory space 1001. The memory space may include conventional volatile memory devices (e.g., RAM), as well as non-volatile memory devices (e.g., disk, flash RAM). Note that the memory space may be an “intended” memory space: for example software modules may be linked in a software development environment for use in a particular memory space in another computer environment outside of the development environment (e.g., in an embedded computer system). The memory space may be subdivided into one or more memory pages 1010.

The example computer system 1000 also has a secondary storage system 1002, which may include a disk, a sequential I/O device such as a tape drive, and/or a serial network connection.

In the example embodiment, the linker/loader 1003, may be provided, e.g., as part of an operating system, or as part of a software development environment. The linker/loader 1003 has access to both the memory space 1001 and the secondary storage system 1002. In the example embodiment of the present invention, a software module to be linked and loaded into a target portion of the memory space 1001 may be read by the linker/loader from the secondary storage system 1002.

The example embodiment may also include a system symbol table 1100, which may be stored in the memory space 1001. The system symbol table may be maintained by a linker/loader application 1003.

The example embodiment may also may include a software module list data structure 1300, that is accessible by linker/loader 1003.

The example embodiment may also a link status information data structure 1400, that is accessible by linker/loader 1003.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A method, comprising:
receiving a software module, the software module including references, at least some of the references being backward references; and
reordering the software module to remove at least some of the backward references.

2. The method according to claim 1, further comprising:
adjusting at least one of the references in the software module to reflect the reordering of the software module.

3. The method according to claim 2,
wherein the software module includes a symbol table, the symbol table including backward references when the steps of reordering the software module and adjusting at least one of the references have been completed.

4. The method according to claim 2,
wherein the software module includes a symbol table, the software module including no backward references in locations before the symbol table when the steps of reordering the software module and adjusting at least one of the references have been completed.

5. The method according to claim 2,
wherein the software module is a relocatable object code module in ELF format when the steps of reordering the software module and adjusting at least one of the reference have been completed.

6. The method according to claim 5,
wherein, when the software module is received, the software module is a relocatable object code module in ELF format, and
wherein, when the steps of reordering the software module and adjusting at least one of the references have been completed, the software module includes a symbol table, the symbol table including backward references, and the software module includes no backward references from locations before the symbol table.

7. The method according to claim 1,
wherein the software module comprises at least one segment, each at least one segment comprising at least one section, and
wherein sections in the same segment are contiguously located in the software module when the step of reordering the software module has been completed.

8. The method according to claim 1,
wherein, when the software module is received, the software module is a relocatable object code module in ELF format.

9. A system, comprising:
a reorder module configured to receive a software module including references, at least some of the references being backward references, the reorder module configured to reorder the software module and remove at least some of the backward references.

10. The system according to claim 9,
wherein the reorder module is configured to adjust a reference in the software module to reflect the reordering of the software module.

11. The system according to claim 9,
wherein the software module includes a symbol table, and
wherein the reorder module is configured not to remove backward references from the symbol table.

12. The system according to claim 9,
wherein the software module includes a symbol table, and
wherein the reorder module is configured to remove all backward references from locations before the symbol table in the reordered software module.

13. The system according to claim 9,
wherein the software module includes at least one segment, each of the at least one segments including at least one section, and the reorder module is configured to locate sections in the same segment contiguously in the reordered software module.

14. The system according to claim 9,
wherein the software module is a relocatable object code module in ELF format, and the reordered software module is a relocatable object code module in ELF format.

15. The system according claim 14,
wherein the software module includes a symbol table,
wherein the reorder module is configured to adjust a reference in the software module to reflect the reordering of the software module,
wherein the reorder module is configured to remove all backward references from locations before the symbol table, and
and wherein the reorder module is configured not to remove backward references from the symbol table.

16. A method, comprising
receiving a software module sequentially, the software module having at least one symbol reference;
loading the software module into a target memory space; and
resolving the at least one symbol reference without storing the entire software module in local memory while the symbol reference is resolved.

17. The method according to claim 16, further comprising:
storing section identification information in local memory while the at least one symbol reference is resolved,
wherein the software module includes at least one section and the section identification information uniquely identifies said at least one section.

18. The method according to claim 16, further comprising:
storing symbol information in local memory, wherein said symbol information is contained in the software module.

19. The method according to claim 16,
wherein the software module includes a data section, and the data section is not stored in local memory while the symbol reference is resolved.

20. The method according to claim 16,
wherein the software module includes a text section, and the text section is not stored in local memory while the at least one symbol reference is resolved.

21. The method according to claim 16,
wherein the software module is a relocatable object code module in ELF format.

22. The method according to claim 21, further comprising:
storing section identification information in local memory while the at least one symbol reference is resolved, wherein the software module includes at least one section and the section identification information uniquely identifies said at least one section; and
storing symbol information in local memory while the at least one symbol reference is resolved, wherein the symbol information is contained in the software module,
wherein the software module includes a data section, and the data section is not stored in local memory while the at least one symbol reference is resolved.

23. A system, comprising:
a linker configured to sequentially receive a software module having at least one symbol reference, the linker configured to resolve the symbol reference, the linker configured to store less than the entire software module in local memory during the resolution of the at least one symbol reference.

24. The system according to claim 23,
wherein the linker is configured to store section identification information in local memory while the linker resolves the at least one symbol reference,
wherein the software module sequentially received by the linker includes at least one section, and
wherein the section identification information stored by the linker uniquely identifies said at least one section.

25. The system according to claim 23,
wherein the linker is configured to store symbol information in local memory while the linker resolves the at least one symbol reference, and
wherein the symbol information is contained in the software module received by the linker.

26. The system according to claim 23,
wherein the software module received by the linker includes a data section, and
wherein the linker is configured not to store the data section in local memory while the linker resolves the at least one symbol reference.

27. The system according to claim 23,
wherein the software module received by the linker includes a text section, and
wherein the linker is configured not to store the text section in local memory while the linker resolves the at least one symbol reference.

28. The system according to claim 23, further comprising:
a system symbol table.

29. The system according to claim 28, wherein
the system symbol table includes a system symbol table entry for the at least one symbol reference, the system symbol table entry including a field indicative of a defining software module which defines the at least one symbol reference.

30. The system according to claim 23, further comprising:
a software module list.

31. The system according to claim 30, wherein the software module list includes a software module list entry for the software module.

32. The system according to claim 23, further comprising:
a link status information data structure.

33. The system according to claim 32, wherein the link status information data structure includes a link status information data structure entry for the software module.

34. The system according to claim 33, further comprising:
a software module list, the software module list including a software module list entry for the software module; and
a system symbol table, the system symbol table including a system symbol table entry for the at least one symbol reference, the system symbol table entry including a field indicative of a defining software module which defines the at least one symbol reference.

35. The system according to claim 23,
wherein the software module received by the linker is a relocatable object code module in ELF format.

36. A software module comprising:
a symbol table, the symbol table including at least one backward reference;
at least one component located before the symbol table in the software module;
wherein none of the at least one components located before the symbol table include backward references.

37. The system according to claim 36,
wherein the software module is in ELF format.

38. An article of manufacture comprising a computer-readable medium having stored thereon instructions adapted to be executed by a processor, the instructions which, when executed, define a series of steps to be used to reorder a software module, said steps comprising:
receiving a software module, the software module including references, at least some of the references being backward references; and
reordering the software module to remove at least some of the backward references.

39. An article of manufacture comprising a computer-readable medium having stored thereon instructions adapted to be executed by a processor, the instructions which, when executed, define a series of steps to be used to control the linking of a software module, said steps comprising:
receiving a software module sequentially, the software module having at least one symbol reference;
loading the software module into a target memory space; and
resolving the at least one symbol reference without storing the entire software module in local memory at one time.
